(19) United States
(12) Patent Application Publication
(10) Pub. No.: US 2022/0335396 A1
(43) Pub. Date: Oct. 20, 2022

(54) SPLIT INTEGRATOR MODEL FOR FACILITATING PURCHASE TRANSACTIONS

(71) Applicant: MASTERCARD INTERNATIONAL INCORPORATED, Purchase, NY (US)

(72) Inventors: Cherie Mok, New York, NY (US); Edward Neil Livingston, Dunfermline, Fife (GB); Eugene Reda, Little Falls, NJ (US); Anup Bisht, Middleton, Milton Keynes (GB); Michael K. McCarthy, Denver, CO (US)

(21) Appl. No.: 17/720,438

(22) Filed: Apr. 14, 2022

Related U.S. Application Data
(60) Provisional application No. 63/177,109, filed on Apr. 20, 2021.

(51) Int. Cl. G06Q 20/16; G06Q 20/32; G06Q 20/12; G06Q 20/40

(52) U.S. Cl. CPC G06Q 20/16; G06Q 20/326; G06Q 20/12; G06Q 20/40; G06Q 20/3255

(57) ABSTRACT

Split integrator model methods and systems for conducting a consumer purchase transaction. In an embodiment, a payment system receives a checkout request message comprising checkout request data from a mobile device application running on a consumer mobile device of a consumer, identifies a payload recipient based on the checkout request data, and then transmits a transaction payload to the payload recipient that includes at least a merchant identifier, payment card account details and a purchase transaction amount. The process also includes the payment system receiving a transaction authorization request from the payload recipient, and then transmitting the transaction authorization request for purchase transaction authorization processing to an issuer financial institution (FI) computer.

### CROSS REFERENCE TO RELATED APPLICATION

This application claims the benefit of U.S. Provisional Patent Application No. 63/177,109 filed on Apr. 20, 2021, the contents of which provisional application are hereby incorporated by reference for all purposes.

### FIELD OF THE INVENTION

Split integrator model methods and systems for facilitating purchase transactions between consumers and merchants are disclosed. More specifically, disclosed methods enable two separate participants in the purchase transaction, such as a mobile wallet operator and a merchant acquirer financial institution, to facilitate the purchase transaction between a consumer and a merchant by having the first participant focus on initiating the purchase transaction while the second participant focuses on acceptance of the purchase transaction.

### BACKGROUND

In order for consumer mobile device electronic payments processing to occur, purchase transaction processing systems typically require mobile wallet providers, payment service providers and merchants to establish and maintain contractual and technical relationships between themselves. In addition, conventional consumer mobile device payment processing requires the entities involved, including the mobile wallet providers, payment service providers (PSPs) and merchants, to be responsible for both the enablement and acceptance of interoperable electronic payments. Thus, a new digital wallet operator that wishes to participate in such mobile device payment systems must have or must establish connections to acquirer financial institutions (FIs) or PSPs in order to participate in electronic purchase transactions between consumers and merchants. However, establishing and maintaining the contractual and technical relationships between all of these parties can be difficult, costly, and time consuming and moreover is often a limiting factor in scaling such solutions across markets. Thus, the contractual and technical relationships between the entities involved in processing and authorizing electronic purchase transactions in conventional payments processing systems can serve as an impediment to new and/or small entities, such as digital wallet operators, that desire to participate in electronic payments processing systems. Such contractual and technical relationships may also server to deter growth of an electronic payments processing system.

A payment service provider (PSP) is an entity that typically is capable of connecting to multiple acquiring financial institutions (FIs) or banks (where merchants have accounts), card networks, and payment networks. Also, the PSP conventionally manages the technical connections, relationships with each external network, and merchant bank accounts and therefore takes care of the technical processing of payment methods for online merchants. This makes the merchant less dependent on financial institutions and free from the task of establishing these connections directly, which is especially advantageous when the merchant is operating internationally.

Payment card accounts provided to consumers by issuing banks, such as credit cards and debit cards, have typically been provided in the form of plastic cards having an electronic chip and/or a magnetic stripe and which store consumer information. Chip cards, or smart cards, or integrated-circuit (IC) cards typically include a microprocessor and a storage device that may be powered during use, for example, by a merchant's reader device. Payment cards also typically include printed information such as the payment card account holder's name, the name of the issuer financial institution (FI) or issuer bank, the name of the payment network (for example, Mastercard™ or Visa™), the user's primary account number (PAN) (which typically follows a standardized format), an expiration date, and a card verification code (CVC) number. Individual payment card types, however, can vary in the amount and/or type of information printed on the card, and how and/or where it is printed. In addition, digitally stored payment card account information must be sufficient to allow the cardholder to utilize the payment card in an appropriate payment protocol, which typically conforms to an “EMV payment protocol,” following the EMV (which stands for “Europay, Mastercard and Visa”) standards for contact or contactless transactions (the EMV standards are published on the EMV website at https://www.emvco.com).

Consumers or cardholders frequently install a mobile banking application or a mobile wallet or a digital wallet that may be supplied by their issuer bank and/or by a mobile wallet provider on their mobile devices (such as a smartphone). Such digital wallets allow consumers to manage their bank accounts, manage their payment card accounts, and participate, for example, in electronic purchase transactions with merchants. When enrolling for a digital wallet account, a digital wallet operator may require a consumer to manually enter payment card account details (such as the consumer's PAN, an expiration date, and a CVC number) into specified fields of a digital wallet interface and/or a merchant interface displayed on a display screen of the consumers' mobile device (i.e., smartphone). However, in some cases such information can be provided by the issuer bank after the consumer provides information authenticating herself to the digital wallet application or to the mobile wallet application running on the consumer mobile device.

In order to enable new participants, such as small or “new” digital wallet operators, into a consumer mobile device payment system, the inventors recognized that it would be desirable to provide methods and systems that facilitate the enablement and acceptance of interoperable electronic payments without requiring the conventional contractual and technical relationships, thus overcoming the above-mentioned problems.

### BRIEF DESCRIPTION OF THE DRAWINGS

Features and advantages of some embodiments of the present disclosure, and the manner in which the same are accomplished, will become more readily apparent upon consideration of the following detailed description taken in conjunction with the accompanying drawings, which illustrate non-limiting example embodiments and which are not necessarily drawn to scale, wherein:

FIG. 1 is a block diagram of a conventional purchase transaction system;

FIG. 2 is a block diagram of a split integrator model system for conducting purchase transactions in accordance with some embodiments of the disclosure;

FIG. 3A is a flow diagram of a split integrator model process for conducting a purchase transaction in accordance with an embodiment of the disclosure;

FIG. 3B is a flow diagram of a split integrator model process for conducting a purchase transaction in accordance with another embodiment of the disclosure; and

FIG. 4 is a block diagram of a payment system computer in accordance with embodiments of the disclosure.

### DETAILED DESCRIPTION

Reference will now be made in detail to various novel embodiments, examples of which are illustrated in the accompanying drawings. The drawings and descriptions thereof are not intended to limit the invention to any particular embodiment(s). On the contrary, the descriptions provided herein are intended to cover alternatives, modifications, and equivalents thereof. In the following description, numerous specific details are set forth to provide a thorough understanding of the various embodiments, but some or all of the embodiments may be practiced without some or all of the specific details. In other instances, well-known process operations have not been described in detail in order not to unnecessarily obscure novel aspects.

A number of terms will be used herein. The use of such terms is not intended to be limiting, but rather are used for convenience and ease of exposition. For example, as used herein, the term “consumer” may be used interchangeably with the term “cardholder” and/or the with the term “user” or “customer” and these terms are used herein to refer to a person, individual, business or other organization that owns (or is authorized to use) a financial account such as a payment card account (for example, a credit card account or a debit card account) or some other type of account (such as a loyalty card account). The term “payment card account” may include a credit card account, a debit card account, a loyalty card account and/or a deposit account or other type of financial account that an account holder or cardholder may access. The term “payment card account number” and/or “primary account number” (PAN) includes a number that identifies a payment card system account and/or a number carried by a payment card, and/or a number that is used to route a transaction in a payment system that handles credit card and/or debit card transactions and the like.

Moreover, as used herein the terms “payment system” and/or “payment network” and/or “payment card system” and/or “payment card network” refer to a system and/or network (which may include one or more computers, computer systems and/or server computers) for processing and/or handling purchase transactions and/or related transactions, which may be operated by a payment card system operator such as MasterCard International Incorporated, or a similar system. In some embodiments, the term “payment card system” may be limited to systems in which member financial institutions (such as banks) issue payment card accounts to individuals, businesses and/or other entities or organizations (and thus are known as issuer financial institutions (FIs) or issuer banks). In addition, the terms “payment system transaction data” and/or “payment network transaction data” or “payment card transaction data” or “payment card network transaction data” refer to transaction data associated with payment or purchase transactions that have been or are being processed over and/or by a payment network or payment system or payment card system or payment card network. For example, payment system transaction data may include a number of data records associated with individual payment transactions (or purchase transactions) of cardholders that have been processed over a payment card system. In some embodiments, payment system transaction data may include information such as data that identifies a cardholder, data that identifies a cardholder's payment device and/or payment card account, transaction date data, transaction time data, transaction amount data, an indication of the merchandise and/or services that have been purchased, and information and/or data identifying a merchant and/or a merchant category. Additional transaction details and/or transaction data may also be available and/or utilized for various purposes in some embodiments.

In general, and for the purposes of introducing concepts of embodiments of the present disclosure, disclosed herein are methods and systems that allow two separate participants to facilitate a purchase transaction between a consumer and merchant. In particular, processes disclosed herein permit a first participant to focus on enablement of payment cards into the payment system and permit a second participant to focus on acceptance of the purchase transaction. Accordingly, in some embodiments a split integrator model is described that allows such functionality. As a result, a digital wallet operator wishing to connect to the payment system does not need to connect to a merchant computer or to a payment service provider (PSP) computer to enable acceptance. Instead, a payment card system operator (such as Mastercard International Incorporated, the assignee of the present application) serves as the facilitator for the purchase transaction. As a result, a wallet participant (consumer) can connect with any merchant or any payment service provider and vice-versa, which advantageously multiplies the enablement and acceptance of purchase transactions in various markets. The split integrator model may also unlock other card on file (“COF”) use cases, wherein the non-payment participants (i.e., the digital wallet providers) can use any type of purchase transaction initiation method to initiate a purchase transaction, including, for example, the use of quick response (QR) codes, consumer biometrics, or other types of consumer actions to signal, start and/or initiate a purchase transaction.

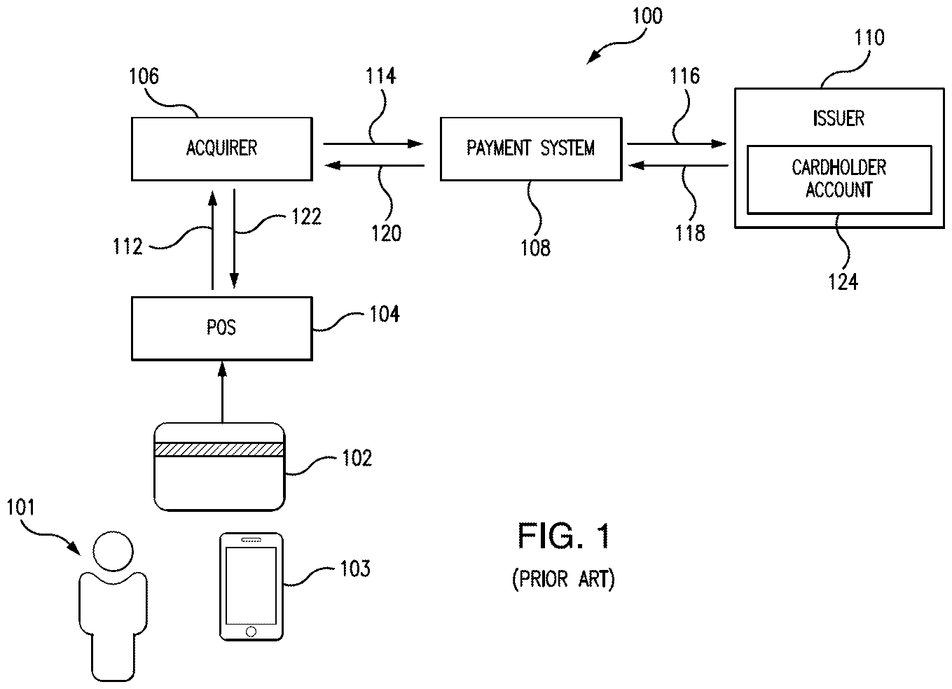

FIG. 1 depicts a conventional payment card system 100. As way of background, to initiate a purchase transaction a customer or consumer 101 may visit a retail store (not shown) operated by a merchant, selects goods (not shown) that she wishes to purchase, and carries the goods to the merchant's point of sale (POS) terminal 104. The consumer 101 then may present a payment card 102 to a reader device (not shown) of the POS terminal 104, or she may use her smartphone 103 which includes a digital wallet having the consumer's payment card account information stored therein, to provide payment card account information to the reader device. The POS terminal 104 reads the customer's payment card account number from the payment card 102 or obtains it from the digital wallet of the consumer's smartphone 103 (which may occur, for example, using near field communication (NFC) technology between a reader device and the smartphone 103), and then transmits 112 an authorization request to an acquirer financial institution (FI) 106 with which the merchant has a relationship. The authorization request typically includes information such as the payment card account number, the amount of the transaction, a merchant identifier and other purchase transaction data or information. The authorization request is then routed 114 to a payment card system 108 (which may be, for example, the well-known Banknet™ system operated by MasterCard International Incorporated, the assignee hereof) which identifies the issuer of the consumer's payment card account and transmits 116 the authorization request to that issuer financial institution (FI) 110.

The issuer 110 receives 116 the authorization request and identifies the cardholder's account 124. Assuming that all is in order (for example, the cardholder's account has sufficient credit to cover the transaction amount), the issuer FI 110 transmits 118 a favorable authorization response to the payment card system 108 which routes 120 it to the acquirer FI 106 which finally transmits 122 the favorable authorization response to the POS terminal 104. The purchase transaction at the POS terminal 104 is then completed and the customer leaves the store with the goods. A subsequent clearing transaction initiated by the merchant results in a transfer of the transaction amount from the customer's payment card account or cardholder account 124 to an account (not shown, but typically maintained by the acquirer bank 106) that belongs to the merchant. The customer's payment card account 124 may be, for example, either a debit card account or a credit card account. In the former case, the clearing transaction results in the funds being debited directly from the account 124. In the latter case, the clearing transaction results in a charge being posted against the account 124, and the charge subsequently appears on the customer's monthly credit card statement.

The foregoing description of a typical purchase transaction between a consumer and a merchant may be considered to be somewhat simplified in some respects. For example, a merchant processing system (not shown) may be interposed between the POS terminal 104 and the acquirer FI 106. As is familiar to those who are skilled in the art, a merchant processing system may be operated by or on behalf of the merchant to form part of the communications path between the acquirer FI and a considerable number of POS terminals operated by the merchant. It is also often the case that a third party transaction processing service, such as a payment services provider (PSP) (not shown), may be included and which may operate to handle payment card transactions on behalf of the acquirer and on behalf of a large number of other like financial institutions.

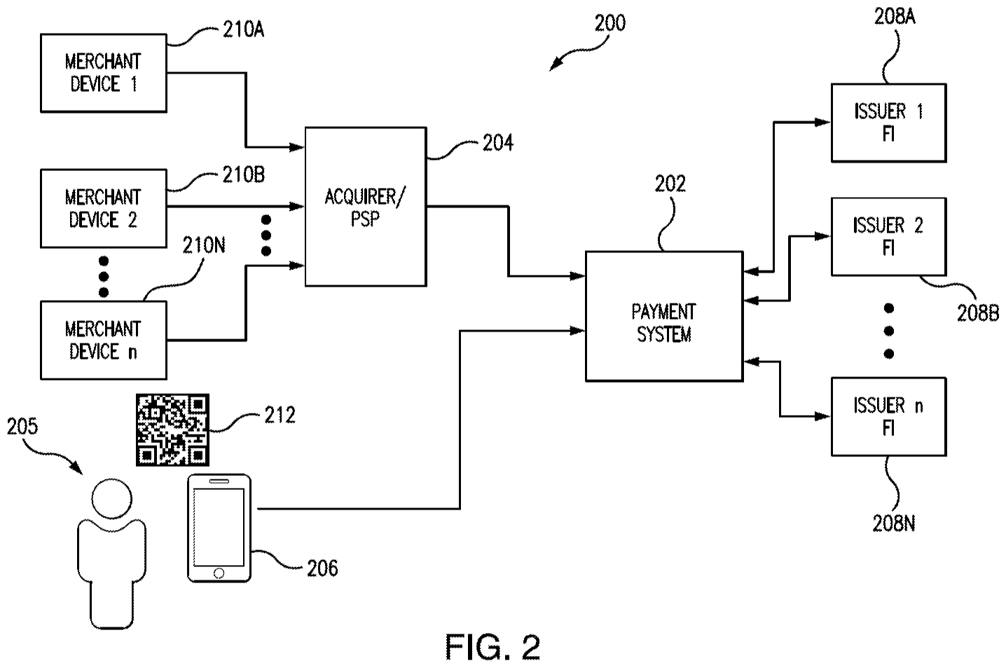

FIG. 2 is a block diagram of a split integrator system 200 for conducting purchase transactions in accordance with some embodiments. In particular, the payment system 202 of the split integrator system 200 operates to onboard two separate types of participants to facilitate the purchase transaction. Specifically, in the disclosed process the digital wallet operator that provided the digital wallet (which is running on the consumer's mobile device 206) to the consumer is responsible for the enrollment and/or enablement of payment cards and for initiating a transaction, whereas the acquirer/PSP 204 is responsible for receiving the transaction payload and completing the transaction. Each participant has a smaller set of responsibilities than typically required of wallet providers, payment service providers (PSPs) and merchants and/or merchant acquirers, which entities are usually responsible for both the enablement and acceptance of interoperable payments.

Referring to FIG. 2, a payment system 202 is operably connected to the acquirer/PSP computer 204, to a consumer mobile device 206 (such as a smartphone, tablet computer, or the like configured for entering into mobile device payment transactions), and to a plurality of issuer financial institution (FI) computers 208A, 208B to 208N. The acquirer/PSP computer 204 is also operably connected to a plurality of merchant devices 210A, 210B to 210N which may be operated by one or more different merchants, and which devices may include one or more of tablet computers, smartphones, personal computers, merchant server computers and the like. In this example, the consumer mobile device 206 is operable by the consumer 205 to conduct purchase transactions with one or more of the merchants and includes at least one digital wallet obtained from a digital wallet operator (which may be an issuer financial institution (FI) digital wallet, for example, or which may be a third party digital wallet obtained from a third party digital wallet provider). In some embodiments, the consumer mobile device 206 is configured to communicate with the payment system 202 via a public network (i.e., the Internet, not shown) and/or through use of a private network (i.e., a telecom network, not shown) and/or combinations thereof.

Each block in FIG. 2 that represents an entity, device, system and/or computer should also be understood to represent one or more computers or devices operated by or on behalf of that entity. In addition, the components of the split integrator system 200 illustrated in FIG. 2 are presented in the context of illustrating an example configuration for conducting a split integrator purchase transaction as disclosed herein. However, a practical embodiment of the split integrator system 200 may be capable of handling a plurality of purchase transaction requests from a plurality of consumers or cardholders, including numerous simultaneous transaction processing requests from a plurality of cardholders utilizing a plurality of different types of consumer mobile devices 206 and involving many different merchants and/or digital wallets and/or payment systems, for example. Therefore, the split integrator system 200 may include additional entities and/or computers and/or computer networks and/or computing resources that also perform at least some of the roles performed by the entities, devices, components and/or computers shown explicitly in FIG. 2.

In some embodiments of the split integrator system 200, a merchant and the Acquirer/PSP must register before split integrator processing can occur. Specifically, some embodiments require that the Acquirer/PSP 204 enter into an acceptance agreement with the payment system 202 wherein, as part of the agreement, the Acquirer/PSP 204 agrees to handle acceptance of purchase transactions between the merchants (which operate merchant devices 210A to 210N) and consumers (such as consumer 205), and wherein the payment system agrees to handle the enablement of payment card accounts for use in the split integrator payment system. In addition, the Acquirer/PSP 204 is responsible for registering each of the merchants wishing to utilize the split integrator system with the payment system 202 (and any other participating payment systems). Upon receiving merchant registration information, the payment system 202 generates unique identifiers for the Acquirer/PSP 204 and for each of the merchants. In some implementations, the Acquirer/PSP 204 then generates a unique quick response (QR) code (based on the unique identifiers provided by the payment system) for each participating merchant which the merchant then displays, for example, at or near the merchant's point-of-sale device(s). The Acquirer/PSP 204 may also create and distribute merchant applications with the unique identifiers for distribution to the merchant devices 210A to 210N that may be used to handle reconciliation and payment receipts. However, it should be understood that in some implementations instead of utilizing QR codes other data capture methods (such as by using barcodes, beacons or identification (ID) numbers) could be utilized by the split integrator system. But in the present example, each merchant receives a unique QR code for display to consumers at the merchant's point-of sale and also downloads a split integrator system application for handling reconciliation and payment receipts, which in some implementations leverages existing payment terminal infrastructure.

Referring again to the split integrator system 200 of FIG. 2, when the consumer 205 wishes to make a payment to a merchant, the digital wallet operator may initiate a transaction through various consumer interactions. For example, the consumer 205 may utilize her consumer mobile device 206 to open a digital wallet application and read a quick response (“QR”) code 212 that is being displayed by a merchant. For example, the QR code 212 (which is a two-dimensional (2D) barcode) may be displayed at a merchant store for conducting purchase transactions, or may be generated by a merchant device 210A, for example, and displayed on a display component (such as a touchscreen) for conducting a purchase transaction.

A QR code is a machine-readable code which consists of an array of black and white squares that convey information. For example, QR codes may store uniform resource locators (URLs) and/or other information that can be read by a camera component of the consumer's mobile device 206. In the context of the disclosed split integrator model process, a retailer may have a sticker, label or sheet of paper posted in a retail store that includes a merchant QR code printed thereon, which can be affixed to a countertop or wall near a cash register (or on the cash register itself). The merchant QR code can include, for example, merchant identification data and a merchant payment account number or merchant payment account data (associated with a financial account of the merchant). In some implementations, the label or sticker containing the merchant QR code printed thereon may be provided to the merchant by a payment processing company (or by a trusted third party).

Referring again to FIG. 2, in an example purchase transaction, the consumer 205 utilizes her consumer mobile device 206 to open a mobile payment application (or digital wallet application), select a payment card account to utilize for the purchase transaction, and then utilizes a camera component (not shown) to scan the merchant's QR code 212. In some implementations, the consumer 205 may also be required to authenticate herself to the digital wallet application before proceeding with the purchase transaction by providing a password and/or biometric data, such as providing a fingerprint to a fingerprint sensor (not shown) and/or such as providing voice input to a microphone (not shown) of the mobile device 206. After the consumer is authenticated by the digital wallet application, the consumer 205 may then be required to review the transaction details which may be displayed on a display component (such as a touchscreen, not shown) of the consumer mobile device, wherein the transaction details may include information such as merchant identification information and credit card account information. The consumer then may be required to enter a purchase transaction amount (the cost or price of the goods or services) and provide an indication to proceed with the purchase. In some embodiments, the mobile payment application or digital wallet application then transmits a checkout request message to the payment system 202 for further processing, wherein the checkout request message includes information such as a merchant identifier, payment card account details and the purchase transaction amount.

Referring again to FIG. 2, the payment system 202 receives the checkout request message from the consumer mobile device 206 and then utilizes the information contained therein to identify a payload recipient (i.e., the merchant acquirer/PSP 204 of the merchant) for the transaction. In some implementations, the payment system next checks or verifies that the merchant acquirer/PSP is registered for split integrator processing, which means that the Acquirer/PSP 204 has already entered into an acceptance agreement with the payment system to handle acceptance of purchase transactions between a merchant or merchants and consumers, and wherein the payment system has agreed to handle the enablement of payment card accounts for use in the split integrator payment system. After verifying that the merchant acquirer/PSP is registered, the payment system then generates a transaction payload which includes information for authorization purposes such as, for example, a merchant identifier, payment card account details and a purchase transaction amount. The transaction payload may include more or less data and/or information which may depend upon requirements of one or more financial institutions and/or the payment system or payment network involved in the processing of the purchase transaction. In embodiments described herein, the payment system 202 next transmits the transaction payload to the merchant Acquirer/PSP computer 204 to be processed within the network. In accordance with the split integrator model process, the Acquirer/PSP computer 204 is only responsible for the acceptance of the transaction (and not responsible for the initiation of the transaction, which is the responsibility of the digital wallet operator). Thus, the Acquirer/PSP computer next generates and submits a transaction authorization request to the payment system 202 which identifies the issuer financial institution (FI) that issued the consumer's payment card account, for example, issuer FI 208A and transmits the transaction authorization request to that issuer FI.

In another embodiment, the consumer 205 initiates a transaction by using her consumer mobile device 206 to open a mobile payment application (or digital wallet application), selects a payment card account to utilize for the purchase transaction, and scans the merchant's QR code 212. The consumer 205 may also be required to authenticate herself to the digital wallet application before proceeding with the purchase transaction, for example, by providing a password and/or biometric data. After the consumer is authenticated by the digital wallet application, the consumer 205 may then be required to review the transaction details which may be displayed on a display component of the consumer mobile device, enter a purchase transaction amount (the cost or price of the goods or services) and provide an indication to proceed with the purchase. In some embodiments, the mobile payment application or digital wallet application then prepares a transaction payload and information identifying a payload recipient, and next transmits the transaction payload to the payment system 202. The payment system 202 uses the information provided to identify the payload recipient (i.e., the merchant acquirer/PSP 204 of the merchant) for the transaction. In some implementations, at this point the payment system verifies that the merchant acquirer/PSP is registered for split integration transaction processing, and if so then sends the transaction payload, which includes information for authorization purposes such as, for example, a merchant identifier, payment card account details and a purchase transaction amount, to the Acquirer/PSP 204 for processing within the network. Thus, in accordance with the split integrator model process, the Acquirer/PSP computer 204 is only responsible for the acceptance of the transaction (and not responsible for the initiation of the transaction, which is the responsibility of the digital wallet operator). The Acquirer/PSP computer next generates and submits a transaction authorization request to the payment system 202 which identifies the issuer financial institution (FI) that issued the consumer's payment card account, for example, issuer FI 208B and transmits the transaction authorization request to that issuer FI.

The issuer FI receives the transaction authorization request and then processes it on a business as usual (“BAU”) basis, by making a determination based on the consumer's credit card account credit limit and other considerations, as to whether or not to authorize the purchase transaction. The issuer FI then transmits a transaction authorization response message back to the Acquirer/PSP computer 204 via the payment system 202 which either authorizes the purchase transaction or declines the transaction. The Acquirer/PSP computer 204 then sends a transaction outcome message to the merchant computer 210A and to the payment system 202. The merchant computer 210A receives the transaction outcome message via, for example, a merchant application and then may display it to the merchant to either confirm a successful purchase transaction or report that the purchase transaction was denied. In some embodiments, the payment system 202 transmits the transaction outcome message to the mobile wallet application running on the consumer's mobile device 206, wherein it may be displayed to the consumer.

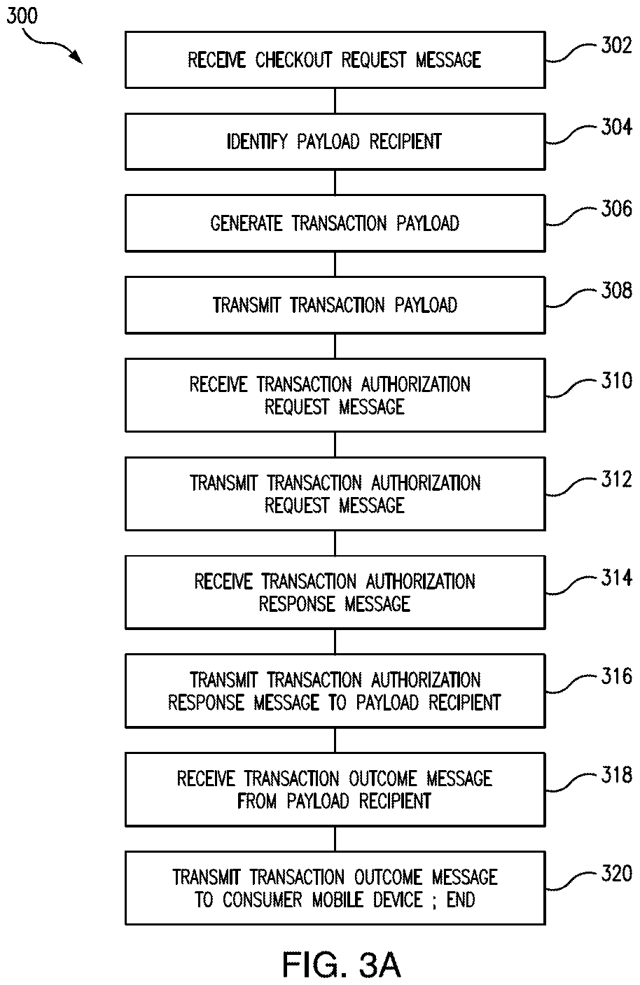

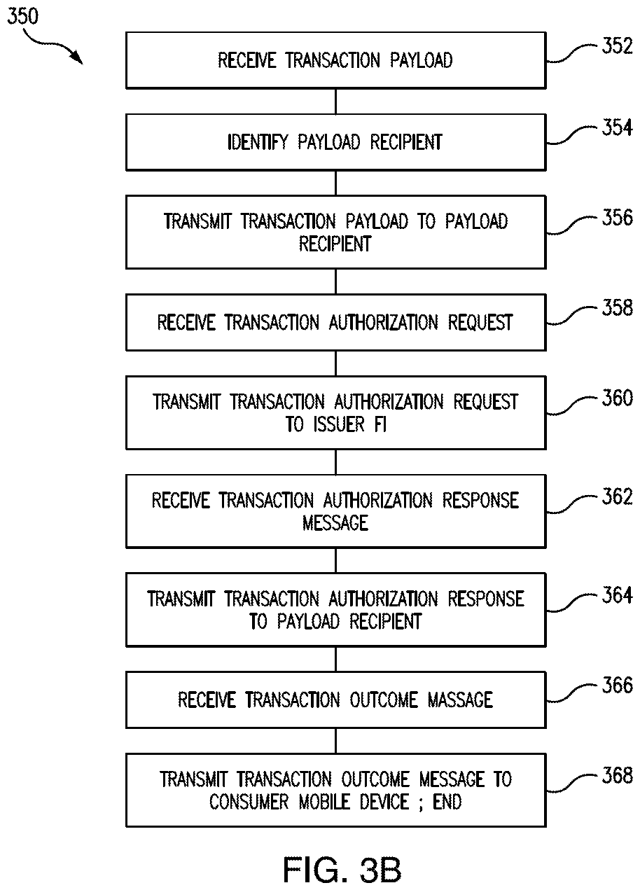

FIG. 3A is a flow diagram of a split integrator model process 300 for conducting a purchase transaction in accordance with some embodiments. In some implementations, the split integrator model process 300 leverages on the infrastructure (operations and technology) that is already provided by a payment services company, such as Mastercard International Incorporated. Accordingly, in embodiments disclosed herein there is no need to add any additional components to those that are already in existence in the electronic payments processing system. However, in some implementations special purpose computers may be used to perform one or more functions as required by the split integrator method to process a purchase transaction.

Referring to FIG. 3A, the payment system 202 (See FIG. 2) receives 302 a checkout request message from a consumer mobile device, and then identifies 304 a payload recipient by using the information contained in the checkout request message. The payload recipient may be, for example, a merchant acquirer financial institution (FI) or a payment service provider (PSP) 204 of the merchant. In some implementations, at this point the payment system verifies that the merchant acquirer/PSP is registered for split integration transaction processing, and if so the payment system then generates 306 a transaction payload which includes information such as a merchant identifier, payment card account details and a transaction amount. The payment system then transmits 308 the transaction payload to the payload recipient, which may be a merchant acquirer FI or a PSP as identified in step 304. Next, the payment system receives 310 a transaction authorization request which includes information that identifies the issuer FI that issued the consumer's payment card account, and transmits 312 that transaction authorization request to that issuer FI. The payment system then receives 314 a transaction authorization response message from the issuer FI and transmits 316 it to the payload recipient (the acquirer FI or PSP identified in step 304). The transaction authorization response message either authorizes the purchase transaction or declines the transaction. Next, the payment system receives 318 a transaction outcome message from the payload recipient, and in some embodiments transmits 320 the transaction outcome message to the consumer mobile device, and the process ends.

FIG. 3B is a flow diagram of a split integrator model process 350 for conducting a purchase transaction in accordance with some other embodiments. The payment system 202 (See FIG. 2) receives 352 a transaction payload from a consumer mobile device and identifies 354 a payload recipient (such as a merchant acquirer FI or a payment service provider (PSP) 204 of the merchant). In some implementations, at this point the payment system verifies that the merchant acquirer/PSP is registered for split integration transaction processing (not shown), and if so then transmits 356 the transaction payload to the payload recipient. Next, the payment system receives 358 a transaction authorization request from the payload recipient (which may be the Acquirer/PSP 204 as shown in FIG. 2) which includes information that identifies the issuer FI that issued the consumer's payment card account. The payment system next transmits 360 the transaction authorization request to the identified issuer FI, and then receives 362 a transaction authorization response message from the issuer FI which is then transmitted 364 to the payload recipient (Acquirer/PSP). The transaction authorization response message either authorizes the purchase transaction or declines the transaction. Next, the payment system receives 366 a transaction outcome message from the Acquirer/PSP, and in some embodiments transmits 368 the transaction outcome message to the consumer mobile device, and the process ends.

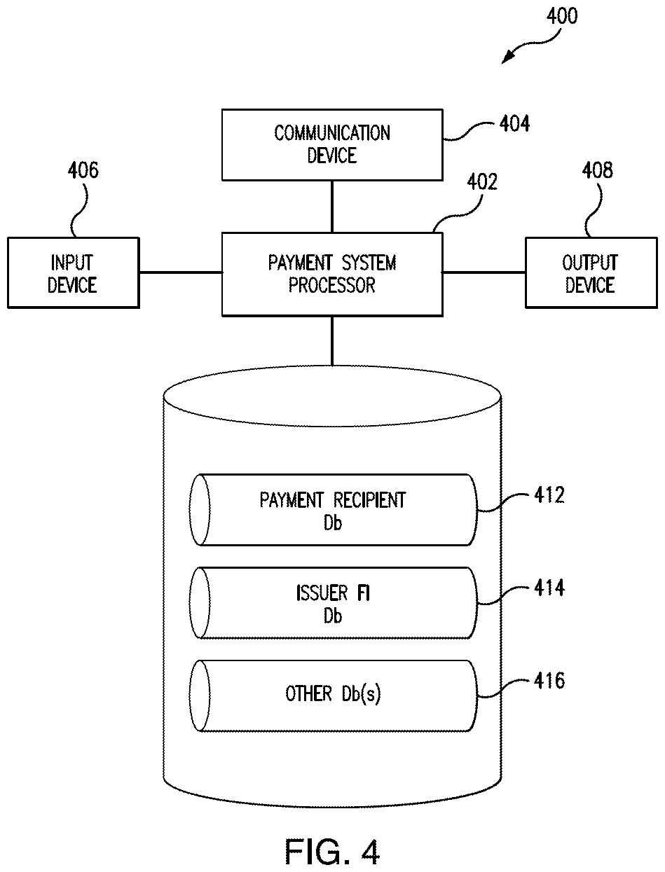

FIG. 4 is a block diagram of a payment system computer 400 configured for implementing the split integrator model according to an embodiment. The payment system computer 400 may be controlled by software to cause it to operate in accordance with aspects of the split integrator model methods presented herein purchase transactions. In particular, the payment system computer 400 may include a payment system processor 402 operatively coupled to a communication device 404, an input device 406, an output device 408, and a storage device 410. However, it should be understood that, in some embodiments the payment system computer 400 may include several computers or a plurality of server computers that work together as part of a system to facilitate purchase transactions in accordance with the split integrator model process. In such a system, one or more computers in communication with one or more other computers may be utilized to scale up computer availability for split integrator model processing if and/or when greater workloads are encountered.

The payment system processor 402 may constitute one or more processors that operate to execute processor-executable steps, contained in program instructions described herein, so as to provide the desired functionality.

Communication device 404 may be used to facilitate communication with, for example, electronic devices such as other computer systems, issuer FI computers, merchant acquirer FI computers, PSP computers and various types of consumer mobile devices. The communication device 404 may, for example, have capabilities for engaging in data communication over the Internet, over different types of computer-to-computer data networks, and/or may have wireless communications capability. Any such data communication may be in digital form and/or in analog form.

Input device 406 may comprise one or more of any type of peripheral device typically used to input data into a computer. For example, the input device 406 may include a keyboard, a computer mouse and/or a touchpad or touch screen. Output device 408 may comprise, for example, a display screen and/or a printer.

Storage device 410 may include any appropriate information storage device, storage component, and/or non-transitory computer-readable medium, including but not limited to combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as flash memory devices. Any one or more of the listed storage devices may be referred to as a “memory”, “storage” or a “storage medium.”

Thus, it should be understood that the term “computer-readable medium” as used herein refers to any non-transitory storage medium that participates in providing data (for example, computer executable instructions or processor executable instructions) that may be read by a computer, a processor or a like device. Such a medium may take many forms, including but not limited to, non-volatile media and volatile media. Non-volatile media may include, for example, optical or magnetic disks and other persistent memory. Volatile media may include dynamic random access memory (DRAM), which typically constitutes the main memory. Common forms of computer-readable media include, for example, a floppy disk, a flexible disk, hard disk, magnetic tape, a solid state drive (SSD), any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Various forms of computer readable media may be involved in providing sequences of computer processor-executable instructions to a processor. For example, sequences of instruction (i) may be delivered from RAM to a processor, (ii) may be wirelessly transmitted, and/or (iii) may be formatted according to numerous formats, standards or protocols, such as Transmission Control Protocol, Internet Protocol (TCP/IP), Wi-Fi, Bluetooth, TDMA, CDMA, and 3G.

Referring again to FIG. 4, storage device 410 stores one or more programs for controlling the processor 402. The programs comprise program instructions that contain processor-executable process steps of the payment processor network computer 400, including, in some cases, process steps that constitute processes provided in accordance with principles of the processes presented herein.

The storage device 410 may also include a payload recipient database 412 which contains information identifying registered merchant Acquirers and/or PSP's associated with various merchants, an issuer FI database 414 including information identifying a plurality of issuer FIs, and one or more Other database(s) 418. The Other database(s) may include computer executable instructions for controlling the payment system processor computer 400 to process data and/or information in a manner to implement split integrator model processing as described herein. The storage device may also have connectivity to other databases (not shown) which may be required for operating the payment processor network computer 400.

Application programs and/or computer readable instructions run by the payment system computer 400, as described above, may be combined in some embodiments, as convenient, into one, two or more application programs. Moreover, the storage device 410 may store other programs or applications, such as one or more operating systems, device drivers, database management software, web hosting software, and the like.

Thus, the split integrator model methods and systems described herein solve the technological problem of how to utilize existing payment transaction infrastructure to facilitate communications between all participants in consumer mobile device purchase transactions in a manner that permits smaller entities and/or new players in the digital purchase transaction space to participate. In addition, the split integrator model does not require a digital wallet operator or other participants to establish and maintain contractual and technical relationships between all of the parties (merchants, Acquirer FIs, PSPs and issuer FIs), which can be difficult and costly, and which is often a limiting factor in scaling payment solutions across markets. The disclosed split integrator model process achieves these goals by advantageously splitting the purchase transaction enablement responsibilities and purchase transaction acceptance responsibilities between different entities. In some embodiments, a payment system computer acts as an intermediary and/or facilitator between the participants in the purchase transaction. Accordingly, in some implementations of the split integrator process a digital wallet operator is responsible for enrollment and/or enablement of consumer payment card accounts and for initiating the purchase transaction, while an acquirer FI (of a merchant) or a payment service provider (PSP) used by a merchant is responsible for receiving a transaction payload and then completing the purchase transaction (either having the purchase transaction authorized or denied). In some embodiments, prior to conducting split integration transaction processing registration of the merchant acquirer/PSP with the payment system is required to establish an agreement concerning the processing responsibilities of each entity, as explained above. In this manner, small or new entities, such as new digital wallet providers, can participate in an electronic payments transaction system without the need to establish and maintain contractual and technical relationships with all the other entities and/or participants in the payments transaction system.

Thus, the split integrator solution beneficially enables new participants to participate in the electronic payment system environment, and the disclosed methods can advantageously be implemented in Secure Remote Commerce (SRC), wherein the participants (merchants, Acquirer/PSPs, payment systems) can focus on either enablement or acceptance without having to have contractual and technical relationships with all of the parties. Such processing also beneficially grows the Card-on-File (COF) use cases wherein consumers can initiate purchase transactions by using a digital wallet application or a mobile payment application obtained from a digital wallet operator (wherein such digital wallets contain payment card account information and/or identification data of the consumers) that does not have direct connections to Acquirer FIs or PSPs for purchase transaction acceptance.

The foregoing diagrams represent logical architectures for describing processes according to some embodiments, and actual implementations may include more, or different components that may be arranged differently. In addition, other topologies may be used in conjunction with other embodiments. Moreover, each system described herein may be implemented by any number of computing devices in communication with one another via any number of other public and/or private networks. Two or more of such computing devices may be located remotely from one another and may communicate with one another via any known manner of network(s) and/or via a dedicated connection. Each computing device may comprise any number of hardware and/or software elements suitable to provide the functions described herein as well as any other functions. For example, any computing device used in an implementation of the system 200 shown in FIG. 2 may include one or more processors to execute program code such that the computing device operates as described herein.

As noted above, systems and processes discussed herein may be embodied in processor executable instructions or program code stored on one or more computer-readable non-transitory media. Such non-transitory media may include, for example, a fixed disk, a floppy disk, a CD-ROM, a DVD-ROM, a Flash drive, magnetic tape, and solid-state RAM or ROM storage units. Embodiments are therefore not limited to any specific combination of hardware and software. As will be appreciated based on the foregoing specification, the above-described examples of the disclosure may be implemented using computer programming or engineering techniques including computer software, firmware, hardware or any combination or subset thereof.

The computer programs (also referred to as programs, computer instructions, software, software applications, “apps”, or code) may include machine instructions for a programmable processor and may be implemented in a high-level procedural and/or object-oriented programming language, and/or in assembly/machine language. Accordingly, in some embodiments instructions stored in a storage device may include processor executable instructions which when executed cause a computer processor to operate in accordance with the split integrator methods disclosed herein.

As used herein, the term “computer” should be understood to encompass a single computer or two or more computers in communication with each other.

As used herein, the term “processor” should be understood to encompass a single processor or two or more processors in communication with each other.

As used herein, the term “memory” should be understood to encompass a single memory or storage device or two or more memories or storage devices.

As used herein, a “server” includes a computer device or computer system that responds to numerous requests for service(s) from other devices.

The above descriptions and illustrations of processes herein should not be considered to imply a fixed order for performing the process steps. Rather, the process steps may be performed in any order that is practicable, including simultaneous performance of at least some steps and/or omission of steps.

Although the present disclosure has been described in connection with specific example embodiments, it should be understood that various changes, substitutions, and alterations apparent to those skilled in the art can be made to the disclosed embodiments without departing from the spirit and scope of the disclosure and/or the invention.

What is claimed is:

1. A split integrator model method for conducting a consumer purchase transaction comprising:
receiving, by a payment system from a mobile device application running on a consumer mobile device of a consumer, a checkout request message comprising checkout request data;
identifying, by the payment system based on the checkout request data, a payload recipient;
transmitting, by the payment system to the payload recipient, a transaction payload comprising at least a merchant identifier, payment card account details and a purchase transaction amount;
receiving, by the payment system from the payload recipient, a transaction authorization request; and
transmitting, by the payment system to an issuer financial institution (FI) computer of an issuer FI, the transaction authorization request for purchase transaction authorization processing, wherein the issuer FI issued a payment card account being used in the purchase transaction to the consumer.

2. The method of claim 1, further comprising verifying, by the payment system prior to transmitting a transaction payload, that the payload recipient is registered for split integrator transaction processing.

3. The method of claim 1, further comprising:
receiving, by the payment system from the issuer FI, a transaction authorization response message;
transmitting, by the payment system to the payload recipient, the transaction authorization response message; and
receiving, by the payment system from the payload recipient, a transaction outcome message.

4. The method of claim 3, further comprising transmitting, by the payment system, the transaction outcome message to the consumer mobile device.

5. The method of claim 1, wherein the checkout request data comprises payment card account details of a consumer payment card account, a merchant identifier and a purchase transaction amount.

6. The method of claim 5, wherein the checkout request data further comprises issuer financial institution identification data.

7. The method of claim 1, wherein identifying the payload recipient comprises using, by the payment system, information contained in the checkout request message to identify one of a merchant acquirer financial institution or a payment service provider.

8. A split integrator model system for conducting a consumer purchase transaction comprising:
a payment system computer;
a consumer mobile device operably connected to the payment system;
a plurality of payload recipient computers operably connected to the payment system; and
a plurality of issuer computers operably connected to the payment system wherein the payment system computer comprises a payment system processor operably connected to a communication device and to a storage device, wherein the storage device comprises processor-executable instructions which when executed cause the payment system processor to:
receive, via the communication device from a mobile device application running on the consumer mobile device, a checkout request message comprising checkout request data;
identify a payload recipient based on the checkout request data;
transmit a transaction payload to a payload recipient computer of the payload recipient, wherein the transaction payload comprises at least a merchant identifier, payment card account details and a purchase transaction amount;
receive a transaction authorization request from the payload recipient computer; and
transmit the transaction authorization request for purchase transaction authorization processing to an issuer financial institution (FI) computer that issued a payment card account being used in the purchase transaction to the consumer.

9. The system of claim 8 wherein the payload recipient comprises one of an acquirer computer or a payment services provider computer, and wherein the storage device stores further processor executable instructions which when executed causes the payment system processor to verify, prior to transmitting a transaction payload, that the payload recipient is registered for split integrator transaction processing.

10. The system of claim 8 wherein the storage device stores further processor executable instructions which when executed causes the payment system processor to:
receive a transaction authorization response message from the issuer FI;
transmit the transaction authorization response message to the payload recipient; and
receive a transaction outcome message from the payload recipient.

11. The system of claim 11 wherein the storage device stores further processor executable instructions which when executed causes the payment system processor to transmit the transaction outcome message to the consumer mobile device.

12. A split integrator model method for conducting a consumer purchase transaction comprising:
receiving, by a payment system computer from a mobile device application running on a consumer mobile device of a consumer, a transaction payload associated with a payment transaction, wherein the transaction payload comprises at least a merchant identifier, payment card account details and a purchase transaction amount;
identifying, by the payment system computer based on the transaction payload, a payload recipient;
transmitting, by the payment system to a payload recipient computer of the payload recipient, the transaction payload;
receiving, by the payment system computer from the payload recipient computer, a transaction authorization request; and
transmitting, by the payment system computer to an issuer financial institution (FI) computer of an issuer FI, the transaction authorization request for purchase transaction authorization processing, wherein the issuer FI issued a payment card account being used in the purchase transaction to the consumer.

13. The method of claim 12, further comprising verifying, by the payment system computer prior to transmitting the transaction payload, that the payload recipient computer is registered for split integrator transaction processing.

14. The method of claim 12, further comprising:
receiving, by the payment system computer from the issuer FI computer, a transaction authorization response message;
transmitting, by the payment system computer to the payload recipient computer, the transaction authorization response message; and
receiving, by the payment system computer from the payload recipient computer, a transaction outcome message.

15. The method of claim 14, further comprising transmitting, by the payment system computer, the transaction outcome message to the consumer mobile device.

16. The method of claim 12, wherein the checkout request data comprises payment card account details of a consumer payment card account, a merchant identifier and a purchase transaction amount.

17. The method of claim 16, wherein the checkout request data further comprises issuer financial institution identification data.

18. The method of claim 12, wherein identifying the payload recipient comprises using, by the payment system computer, information contained in the checkout request message to identify one of a merchant acquirer financial institution or a payment service provider.

19. A split integrator model system for conducting a consumer purchase transaction comprising:
a payment system computer;
a consumer mobile device operably connected to the payment system;
a plurality of payload recipient computers operably connected to the payment system; and
a plurality of issuer computers operably connected to the payment system
wherein the payment system computer comprises a payment system processor operably connected to a communication device and to a storage device, wherein the storage device comprises processor-executable instructions which when executed cause the payment system processor to:
receive, from a mobile device application running on a consumer mobile device of a consumer, a transaction payload associated with a payment transaction, wherein the transaction payload comprises at least a merchant identifier, payment card account details and a purchase transaction amount;
identify a payload recipient computer of a payload recipient based on the transaction payload;
transmit the transaction payload to the payload recipient computer;
receive a transaction authorization request from the payload recipient computer; and
transmit the transaction authorization request for purchase transaction authorization processing to an issuer financial institution (FI) computer of an issuer FI, wherein the issuer FI issued a payment card account being used in the purchase transaction to the consumer.

20. The system of claim 19 wherein the payload recipient comprises one of an acquirer computer or a payment services provider computer, and wherein the storage device stores further processor executable instructions which when executed causes the payment system processor to verify, prior to transmitting a transaction payload, that the payload recipient is registered for split integrator transaction processing.
